(19) United States
(12) Patent Application Publication
(10) Pub. No.: US 2007/0114092 A1
(43) Pub. Date: May 24, 2007

(54) Hydraulic brake and steering system

(75) Inventors: Rabie E. Khalil, Dunlap, IL (US); Edward W. Mate, Manhattan, IL (US); John J. Kaufman, Joliet, IL (US); Brad A. Edler, Waterloo, IL (US); Xiaodong Huang, Peoria, IL (US); Mark L. Westphalen, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/261,541

(22) Filed: Oct. 31, 2005

(51) Int. Cl. B62D 5/00

(52) U.S. Cl. 180/406

(57) ABSTRACT

A hydraulic system is disclosed. The hydraulic system includes a source of pressurized fluid and a plurality of fluid actuators configured to affect an amount of resistive torque applied to an associated traction device. The hydraulic system also includes a plurality of valves each configured to selectively communicate pressurized fluid to one of the plurality of fluid actuators. The hydraulic system further includes a controller configured to control the plurality of valves as a function of at least a steering command.

### TECHNICAL FIELD

The present disclosure relates to a hydraulic system and, more particularly, to a hydraulic brake and steering system.

### BACKGROUND

Vehicles such as, for example, automobiles, trucks, work machines, and other types of vehicles, often include one or more traction devices to affect movement of the vehicle relative to the ground or other surface. These traction devices are driven by a vehicle power device and are often controlled with multiple hydraulic systems to affect steering or braking of the traction devices. Vehicles often include three separate hydraulic systems, one hydraulic system configured to affect braking and two hydraulic systems, a primary and a secondary system, configured to affect steering. The secondary hydraulic system is typically a redundant, back-up system and is configured to affect steering upon malfunction or failure of the primary hydraulic system. Each of these hydraulic systems often includes an electro-hydraulic valve arrangement fluidly connected between a pump and one or more actuators to control a flow rate and direction of pressurized fluid to and from chambers of the one or more actuators. As such, the valve arrangement affects braking or steering, such as, for example, by moving an actuator to affect the engagement of mechanical brakes relative to a moving part of the traction devices or by moving an actuator to affect the angle of one or more traction devices relative to a vehicle frame. Although vehicles having three separate hydraulic systems may establish adequate control of the traction devices, multiple hydraulic systems may increase the complexity of the vehicle.

U.S. Pat. No. 6,935,445 (“the '445 patent”) issued to Johnson discloses a back-up steering system for track laying vehicles when a primary steering system is not properly functioning. The '445 patent discloses a hydraulic system having a plurality of valves connected between a pump and left and right service brakes. Simultaneous actuation of the services brakes acts to slow an associated vehicle and independent actuation of the service brakes acts to steer the associated vehicle. Specifically, the '445 patent discloses an electrically controlled main valve which selectively directs fluid toward a mode control valve to hydraulically bias movement thereof. Upon actuation of the main valve, the mode control valve responsively communicates fluid from the pump to the service brakes for simultaneous actuation thereof. The '445 patent also discloses a pair of back-up solenoid valves which selectively and independently communicate fluid from the pump to one of the service brakes via the mode control valve. As such, the '445 patent provides dual control of the right and left service brakes in either a normal braking mode, e.g., actuation of the main valve, or a back-up mode, e.g., actuation of one or both of the back-up valves.

Although the '445 patent may provide a back-up steering system to control a track laying vehicle when a primary steering system is not properly function, the disclosed system may not be capable of increasing the maneuverability of the associated vehicle during proper functioning of the primary steering system. Additionally, the '445 patent may disconnect the normal braking system when providing back-up steering to the associated vehicle. Furthermore, the '445 patent may require a complex valve arrangement and control method to achieve back-up steering control of the associated vehicle.

The present disclosure is directed to overcoming one or more of the problems set forth above.

### SUMMARY OF THE INVENTION

In one aspect, the present disclosure is directed to a hydraulic system. The hydraulic system includes a source of pressurized fluid and a plurality of fluid actuators configured to vary an amount of resistive torque applied to an associated traction device. The hydraulic system also includes a plurality of valves, each configured to selectively communicate pressurized fluid to one of the plurality of fluid actuators. The hydraulic system further includes a controller configured to control the plurality of valves as a function of at least a steering command.

In another aspect, the present disclosure is directed to a method of operating a hydraulic system. The method includes pressurizing a fluid and directing pressurized fluid to a plurality of valves, each one of the plurality of valves operatively associated with one of a plurality of actuators. The method also includes selectively directing pressurized fluid through each of the plurality of valves toward the plurality of actuators as a function of a first signal. The method further includes selectively directing pressurized fluid through a subgroup of the plurality of valves as a function of a second signal.

### BRIEF DESCRIPTION OF THE DRAWINGS

FIG. 1 is an exemplary diagrammatic illustration of a vehicle in accordance with the present disclosure; and

FIG. 2 is an exemplary schematic illustration of a hydraulic system of the vehicle of FIG. 1.

### DETAILED DESCRIPTION

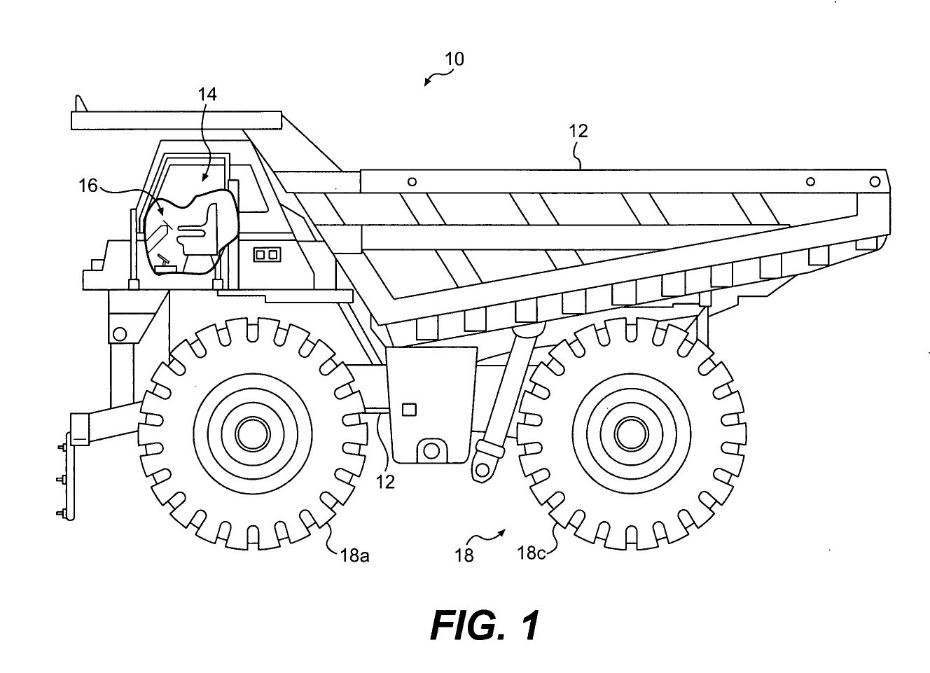

FIG. 1 illustrates an exemplary vehicle 10. Vehicle 10 may embody an automobile, a truck, a work machine, and/or any mobile vehicle. For clarification purposes only, vehicle 10 is illustrated as a dump truck, however, it is noted that the disclosure herein is applicable to any mobile vehicle. Specifically, vehicle 10 may include a frame 12, an operator interface 14, and a plurality of traction devices 18.

Frame 12 may include any structural unit that supports movement of vehicle 10. Frame 12 may be, for example, a stationary base frame connecting a power source to traction devices 18, e.g., a chassis, a movable frame member connecting one or more implements to a power source, e.g., a linkage system, and/or any other type of frame known in the art.

Operator interface 14 may be configured to receive inputs from an operator indicative of a desired operation, such as, for example, movement of frame 12, traction devices 18, and/or any other suitable operation of vehicle 10. Specifically, operator interface 14 may include one or more operator interface devices 16 that may include proportional-type controllers, such as, for example, pedals and/or steering wheels, configured to position and/or orient components of vehicle 10. It is contemplated that additional and/or different operator interface devices 16 may be included within operator interface 14 such as, for example, multi-axis joysticks, knobs, push-pull devices, switches, and/or other operator interface devices known in the art.

Traction devices 18 may include wheels, tracks, and/or other mechanisms configured to support and/or affect the yaw of vehicle 10 with respect to a surface such as, for example, the ground. Each of traction devices 18 may or may not be steerable and may include any number of mechanisms at one or more locations relative to frame 12, e.g., one of traction devices 18 may include two adjacent wheels cooperatively coupled to one another. For example, vehicle 10 may include a first, second, third, and fourth traction device 18a, 18b, 18c, 18d, two of which, first and third traction devices 18a, 18c, are illustrated in FIG. 1. For clarification purposes only, first, second, third, and fourth traction devices 18a, 18b, 18c, 18d, may be considered as a front left, front right, rear left, and rear right traction device, respectively, as conventionally referenced with respect to a mobile vehicle. It is contemplated that traction devices 18 may be configured by any conventional arrangement such as, for example, enabling steering of each of traction devices 18 or enabling steering of only first and second traction devices 18a, 18b. It is also contemplated that traction devices 18 may be operatively connected together, to frame 12, and/or to a power source of vehicle 10 in any conventional manner including, for example, a drive train, differential gear transfers, shock absorbing mechanisms and/or other suitable mechanisms. It is further contemplated that each of traction devices 18 may include one or more individual mechanisms arranged adjacent to one another, such as, for example, providing each of third and fourth traction devices 18c, 18d with two wheels each as is conventionally known in the art.

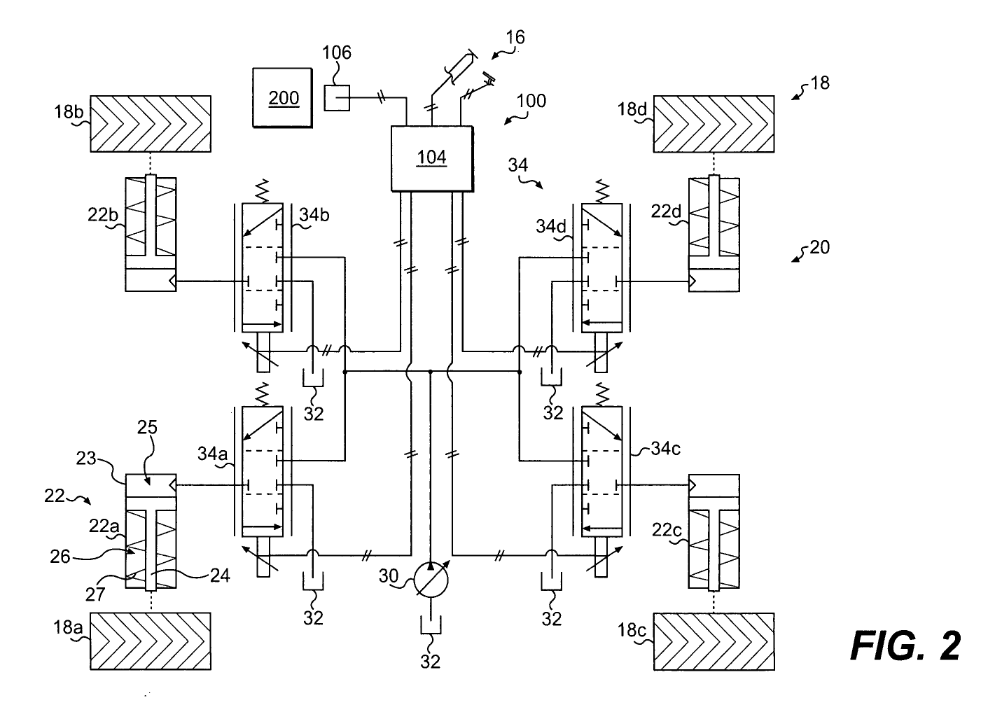

As illustrated in FIG. 2, traction devices 18 may each be operably connected to a hydraulic system 20. Specifically, hydraulic system 20 may include one or more hydraulic actuators 22 each configured to affect the engagement of a mechanical brake and thus the amount of resistive torque applied to a respective one of traction devices 18. The mechanical brake system may include any conventional brake system configured to apply a resistive torque to one of traction devices 18 as a function of an extension and/or retraction of a hydraulic actuator. For example, the mechanical brake system may include a disc brake apparatus wherein calipers thereof may frictionally engage a brake disc as a function of the extension and/or retraction of an associated hydraulic actuator. As such, for clarification purposes, a further description of the mechanical brake system is omitted. It is contemplated that the speed of movement of one of traction devices 18 may be a function of the amount of resistive torque applied thereto.

Hydraulic actuators 22 may each be respectively associated with one of traction devices 18. For example a first, second, third, and fourth actuator 22a, 22b, 22c, 22d may be respectively associated with first, second, third, and fourth traction devices 18a, 18b, 18c, 18d. Further description of hydraulic actuators 22 is made below with reference to first actuator 22a for clarification purposes only, and it is noted that the description thereof is applicable to second, third, and fourth actuators 22b, 22c, 22d.

First hydraulic actuator 22a may include a tube 23 defining a cylinder and a piston 24 separating the cylinder into a first chamber 25 configured to contain pressurized fluid and a second chamber 26 configured to contain a spring 27. Piston 24 may be movable in a first direction in response to fluid pressure supplied to first chamber 25 and may be movable in a second direction, opposite the first direction, in response to spring 27 within second chamber 26. Specifically, pressurized fluid within first chamber 25 may bias piston 24 in the first direction to increase the frictional engagement of a mechanical brake operably connected with first traction device 18a. Conversely, spring 27 within second chamber 26 may bias piston 24 in the second direction to decrease the frictional engagement of the mechanical brake operably connected to first traction device 18a. As such, the amount of engagement of the mechanical brake, and thus the amount of resistive torque applied to first traction device 18a, may be a function of the amount of pressurized fluid supplied to first chamber 25. It is contemplated that hydraulic actuators 22 may alternatively be spring biased toward a extended position and hydraulically biased toward a retracted position.

Hydraulic system 20 may also include a source 30 of pressurized fluid, a low pressure source 32, and one or more valves 34 to affect the extension and/or retraction of hydraulic actuators 22. It is contemplated that hydraulic system 20 may include a plurality of fluid passages fluidly communicating one or more components with one another as is conventional in the art. It is also contemplated that hydraulic system 20 may include additional and/or different components such as, for example, temperature sensors, position sensors, relief valves, accumulators, pressure regulators, and/or other components known in the art. It is further contemplated that hydraulic system 20 may also be configured to affect engagement of stationary, e.g., parking, brakes, on one or more of traction devices 18.

Source 30 may be configured to produce a flow of pressurized fluid and may include a variable displacement pump, a fixed displacement pump, and/or other sources of pressurized fluid known in the art. Source 30 may be drivably connected to a power source by, for example, a countershaft, a belt, an electrical circuit, or in any other suitable manner. Source 30 may be disposed upstream of low pressure source 32 and may supply pressurized fluid to valves 34. It is contemplated that source 30 may alternatively include a plurality of pumps configured as stage pumps as is conventional in the art.

Low pressure source 32 may include, for example, a reservoir or a tank, configured to hold a supply of fluid. The fluid may include, for example, a dedicated hydraulic oil, an engine lubrication oil, a transmission lubrication oil, or any other fluid known in the art. One or more hydraulic systems within vehicle 10 may draw fluid from and return fluid to low pressure source 32. It is contemplated that hydraulic system 20 may be connected to multiple separate low pressure sources.

Valves 34 may include first, second, third, and fourth valves 34a, 34b, 34c, 34d, each respectively associated with first, second, third, and fourth hydraulic actuators 22a, 22b, 22c, 22d. Valves 34 may each be configured to regulate a flow of pressurized fluid to one of hydraulic actuators 22. Specifically, valves 34 may each include a proportional valve element that may be spring biased and solenoid actuated to move the valve element toward any of a plurality of positions. Further description of valves 34 is made with reference to first valve 34a for clarification purposes only, and it is noted that the description thereof is applicable to second, third, and fourth valves 34b, 34c, 34d.

For example, the valve element of first valve 34a may be movable from a first position in which a flow of pressurized fluid may be substantially blocked from flowing toward first hydraulic actuator 22a. The valve element may also be movable from the first position toward either a second position, in which a maximum flow of pressurized fluid may be allowed to flow from source 30 toward first hydraulic actuator 22a, or a third position, in which a maximum flow of pressurized fluid may be allowed to flow from first hydraulic actuator 22a toward low pressure source 32. It is contemplated that first valve 34a may alternately be hydraulically actuated, mechanically actuated, pneumatically actuated, or actuated in any other suitable manner. It is also contemplated that first valve 34 may include a plurality of independent metering valves, a fixed flow area valve, and/or any other valve arrangement known in the art. It is noted that the amount of frictional engagement of the mechanical brake and thus the amount of resistive torque applied to first traction device 18a may be a function of the amount of actuation of the valve element of first valve 34a and, correspondingly, the amount of flow area through which pressurized fluid is allowed to flow.

As also illustrated in FIG. 2, hydraulic system 20 may be controlled by a control system 100. Specifically, control system 100 may be configured to receive operator inputs via operator interface devices 16 and operate one or more components of hydraulic system 20 in response thereto. Specifically, control system 100 may include a controller 104 and a sensor 106 and may be configured to control movement of valves 34. It is contemplated that control system 100 may include additional components such as, for example, signal communication lines, amplifiers, filters, power devices, and/or other components known in the art.

Controller 104 may include one or more microprocessors configured to control the operation of hydraulic system 20. Controller 104 may include a memory, a data storage device, a communications hub, and/or other components known in the art. Specifically, controller 104 may be configured to receive inputs from operator interface devices 16 and sensor 106. Controller 104 may also be configured to perform one or more algorithms and/or access one or more relational databases, such as, for example, maps, equations, and/or look-up tables. Controller 104 may issue commands to valves 34 as a function of the received inputs, the performed algorithms, and/or the accessed databases. For example, controller 104 may issue a signal, e.g., a current or a voltage, to affect movement of the valve elements of valves 34 to selectively control a flow rate, a pressure, and/or a direction of pressurized fluid relative to hydraulic actuators 22. It is contemplated that controller 104 may also receive and/or issue commands to additional components of hydraulic system 20, such as, for example, source 30. It is also contemplated that controller 104 may be configured as a separate controller or be integrated within a general vehicle control system capable of controlling various additional functions of vehicle 10. It is further contemplated that controller 104 may include a plurality of controllers, each configured to control one or more components of hydraulic system 20.

Sensor 106 may include any conventional sensor and may be configured to sense one or more parameters indicative of an operational condition of a separate steering system 200. Sensor 106 may include, for example, a pressure sensor configured to sense a pressure of a pressurized fluid within steering system 200. As such, sensor 106 may communicate a signal to controller 104 which may be compared with an acceptable value or range of values to determine if steering system 200 is malfunctioning, e.g., not properly functioning. It is contemplated that sensor 106 may alternatively be any type of sensor such as, a position sensor, a temperature sensor, a power sensor, a flow sensor, a voltage sensor, a current sensor, and/or any other sensor known in the art. It is also contemplated that control system 100 may include any number of sensors configured to sense one or more parameters of steering system 200.

Steering system 200 may include any conventional system configured to affect the orientation of one or more of traction devices 18 relative to frame 12 to thereby affect and/or control the yaw of vehicle 10 relative to a surface. For example, steering system 200 may include a hydraulic system, an electrical system, and/or a mechanical system. As such, for clarification purposes, a further description of steering system 200 is omitted. It is also contemplated that steering system 200 may be considered to be malfunctioning based on any rationale, such as, for example, insufficient actuation pressure within a hydraulic system, insufficient voltage within an electrical system, less than the desired actuation and/or control of one or more components with the steering system, and/or any other desired criteria. It is further contemplated that steering system

change the orientation of traction devices 18 by changing the angle of traction devices 18 with respect to frame 12 in any suitable orientation.

### INDUSTRIAL APPLICABILITY

The disclosed hydraulic system may be applicable to any vehicle having braking and steering manipulation and/or control of traction devices. The disclosed system may be configured to provide back-up steering capability upon malfunction of a primary steering system and/or augment a functioning primary steering system. The operation of hydraulic system 20 is explained below.

Referring to FIG. 2, source 30 may receive pressurized fluid from low pressure source 32 and supply pressurized fluid to upstream sides of valves 34. Valves 34 may selectively control the flow rate, pressure, and/or direction of pressurized fluid in response to the relative position of a respective valve element thereof. For example, valves 34 may each be movable from the first position, substantially blocking pressurized fluid from flowing toward a respective one of hydraulic actuators 22, toward either the second or third positions. Movement of the valve element of one of valves 34 toward the second position may allow pressurized fluid to flow from source 30 toward a first chamber 25 of an associated one of hydraulic actuators 22 to establish a force capable of compressing spring 27. Movement of the valve element of one of valves 34 toward the third position may allow pressurized fluid to flow from a first chamber 25 of an associated one of hydraulic actuators 22 toward low pressure source 32 to establish a force capable of releasing spring 27. As a result, selective movement of the valve elements of valves 34 may affect selective movement of hydraulic actuators 22 which may, in turn, affect the amount of resistive torque applied to each of traction devices 18.

Hydraulic actuators 22 may be movable in response to operator inputs communicated via operator interface devices 16. For example, a drive torque may be supplied to traction devices 18 via a vehicle drive train to propel vehicle 10 relative to a surface as is conventional in the art. An operator may desire to slow vehicle 10 and, accordingly, may actuate one of operator interface devices 16, e.g., an operator may depress a pedal of vehicle 10. Additionally, an operator may desire to change the direction of vehicle 10 relative to a surface and, accordingly, may actuate another one of operator interface devices 16, e.g., an operator may actuate a steering wheel of vehicle 10. Actuation of one or more of operator interface devices 16 may communicate signals, corresponding to the relative positions thereof, to controller 104. Controller 104 may, in response to one or more received signals, control one or more of valves 34 to allow pressurized fluid to flow from source 30 toward respective hydraulic actuators 22 and/or to allow pressurized fluid to flow from respective hydraulic actuators toward low pressure source 32.

In response to an operator input to slow vehicle 10, controller 104 may control movement of each of valves 34 toward the second positions thereof. For example, controller 104 may control the valve element of first hydraulic valve 34a toward the second position to thereby fluidly communicate pressurized fluid supplied from source 30 toward first chamber 25 of hydraulic actuator 22a. The pressurized fluid supplied to first chamber 25 may act against the bias of spring 27 to affect movement of piston 24 and, as a result, increase the resistive torque applied to traction device 18a. Controller 104 may similarly control second, third, and fourth valves 34b, 34c, 34d, and as a result, vehicle 10 may be slowed as a function of the amount of actuation of one of operator interface devices 16. It is contemplated that controller 104 may be configured to selectively increase the restrictive torque on third and fourth traction devices 18c, 18d a predetermined length of time before increasing the restrictive torque on first and second traction devices 18a, 18b as is conventional in the art, so as to reduce a resulting moment about first and second traction devices 18a, 18b. That is, controller 104 may be configured to increase the resistive torque on the rear traction devices of vehicle 10 before increasing the resistive torque on the front traction devices to reduce a resultant moment which may tend to pivot vehicle 10 about the front traction devices, potentially reducing the traction of third and fourth traction devices 18c, 18d with respect to a surface.

In response to an operator input to change the direction of vehicle 10, e.g., to affect a change in yaw of vehicle 10, controller 104 may selectively control movement of one or more of valves 34 toward the second positions thereof. For example, controller 104 may compare a signal received from sensor 106 with a predetermined value to evaluate the operation state of steering system 200. Controller 104 may determine that steering system 200 is malfunctioning if the signal received from sensor 106 is less than the predetermined value. For example, considering that sensor 106 may include a pressure sensor, controller 104 may determine that steering system 200 is malfunctioning when a received signal is indicative of substantially no or insufficiently low pressure within, for example, a hydraulic steering system 200. Accordingly, controller 104 may be configured to selectively control hydraulic system 20 to achieve the desired steering of vehicle 10. It is contemplated that controller 104 may substantially simultaneously control first and third valves 34a, 34c to substantially simultaneously increase the resistive torque applied to first and third traction devices 18a, 18c. It is also contemplated that controller may similarly control second and fourth valves 34b, 34d and second and fourth traction devices 18b, 18d.

Controller 104 may selectively control hydraulic system 20, and in particular valves 34, to affect steering of vehicle 10 when a steering command is received and it is determined that steering system 200 is malfunctioning. For example, in response to a command to turn vehicle 10 toward the left direction, controller 104 may increase the resistive torque applied to first and third (e.g., left front and rear) traction devices 18a, 18c. Controller 104 may control the respective valve elements of first and third valves 34a, 34c toward the second positions to allow pressurized fluid to flow toward first and third actuators 22a, 22c. As such, first and third traction devices 18a, 18c may be slowed relative to second and fourth (e.g., right front and rear) traction devices 18b, 18d resulting in vehicle 10 turning toward the left direction. Similarly, controller 104 may increase the resistive torque applied to second and fourth (e.g., right front and rear) traction devices 18b, 18d to affect vehicle 10 turning toward the right direction. Specifically, as is known in the art, the traction devices of a vehicle that are on an inner turning radius (e.g., first and third traction devices 18a, 18c when vehicle 10 is turning left), operate at a slower speed than the traction devices that are on the outer turning radius. As such, by selectively slowing first and third 18a, 18c or second and fourth 18b, 18d traction devices, controller 104 may affect turning of vehicle 10 when steering system 200 may be malfunctioning.

Controller 104 may also selectively control hydraulic system 20, and in particular valves 34, to augment steering of vehicle 10 when a steering command is received and it is determined that steering system 200 is not malfunctioning. For example, in response to a command to turn vehicle 10 in a left direction at a particular turning radius, controller 104 may increase the resistive torque applied to first and third (e.g. left front and rear) traction devices 18a, 18c. As such, controller 104 may enable vehicle 10 to establish a turning radius smaller than that which could be established by steering system 200 only controlling the orientation of traction devices 18. It is contemplated that controller 104 may include one or more algorithms and/or receive one or more inputs to indicate that an operator desired turning radius may not be achievable by steering system 200 alone. Specifically, controller may determine that a steering command input from one of operator interface devices 16 is greater than a predetermined limit value, e.g., an operator actuated one of operator interface devices 16 to establish a turning radius of vehicle 10 that steering system 200 alone may not establish without being augmented by hydraulic system 20.

In response to an operator input to change the speed and direction of vehicle 10, e.g., an operator desires slowing and steering of vehicle 10 when steering system 200 is malfunctioning, controller 104 may selectively control movement of one or more of valves 34 as a function of the input to change the speed of vehicle 10 before selectively controlling valves 34 as a function of the input to change the direction of vehicle 10. Specifically, controller 104 may be configured to control valves 34 to suitably affect a desired resistive torque applied to traction devices 18 to establish a desired amount of slowing of vehicle 10 prior to establishing a desired amount of turning of vehicle 10. For example, controller 104 may increase the resistive torque applied to each of traction devices 18 to slow vehicle 10 as described above before additionally increasing a resistive torque applied to first and third traction devices 18a, 18c to establish a turning radius for vehicle 10. As such, controller 104 may be configured to establish operator inputs to slow vehicle 10 as higher priority inputs than operator inputs to change the direction of vehicle 10. It is contemplated that controller 104 may be configured to perform one or more algorithms to establish a desired amount of slowing of vehicle 10 before establishing a desired amount of turning of vehicle 10. It is also contemplated that controller 104 may prioritize operator inputs to slow and turn vehicle 10 by establishing a single command, e.g., a command configured as a function of an operator input to slow and an operator input to turn, or establishing multiple commands, e.g., two commands each separately configured as a function of an operator input to slow or to turn, for each of valves 34 to control the movement thereof in response to an operator input to change the speed and direction of vehicle 10.

Because hydraulic system 20 and, in particular, controller 104, may selectively control the movement of hydraulic actuators 22 and thus may independently control the corresponding amount of resistive torque applied to traction devices 18, hydraulic system 20 may provide a back-up steering system to vehicle 10. As such, a separate, back-up steering system may not be necessary and the complexity of vehicle 10 may be reduced. Also, because hydraulic system 20 and, in particular controller 104, may be configured to affect the turning of vehicle 10 independent of steering system 200, hydraulic system 20 may augment the steering capability vehicle 10. As such, the turning radius of vehicle 10 may be reduced which may increase the maneuverability of vehicle 10. Additionally, because hydraulic system 20 may include control system 100 configured to control valves 34 in response to both operator desired braking and steering commands, steering of turning of vehicle 10 may be accomplished through selective control of a hydraulic braking system without additional components. As such, a simple valve arrangement and controller may be achieved.

It will be apparent to those skilled in the art that various modifications and variations can be made to the disclosed hydraulic system. Other embodiments will be apparent to those skilled in the art from consideration of the specification and practice of the disclosed system. It is intended that the specification and examples be considered as exemplary only, with a true scope being indicated by the following claims and their equivalents

What is claimed is:

1. A hydraulic system comprising:
a source of pressurized fluid;
a plurality fluid actuators each configured to selectively vary an amount of resistive torque applied to an associated traction device;
a plurality of valves each configured to selectively communicate pressurized fluid to one of the plurality of fluid actuators; and
a controller configured to control the plurality of valves as a function of a steering command.

2. The hydraulic system of claim 1, further including a low pressure source wherein each of the plurality of valves is configured to:
selectively allow pressurized fluid to flow from the source toward the at least one actuator to increase the resistive torque; and
selectively allow pressurized fluid to flow from the at least one actuator toward the low pressure source to decrease the resistive torque.

3. The hydraulic system of claim 1, further including:
a first operator interface device configured to communicate a first signal indicative of a braking command to the controller; and
a second operator interface device configured to communicate a second signal indicative of the steering command to the controller;
wherein the controller is configured to selectively control the plurality of valves as a function of both the first signal and the second signal.

4. The hydraulic system of claim 1, wherein:
the plurality of fluid actuators includes at least four fluid actuators each configured to independently affect an amount of resistive torque applied to an associated traction device; and
the controller is further configured to control the plurality of valves to substantially simultaneously increase the resistive torque on a first two traction devices in response to a first steering command and to control the plurality of valves to substantially simultaneously increase the resistive torque on a second two traction devices in response to a second steering command.

5. The hydraulic system of claim 4, wherein the hydraulic system is configured as a combined brake system and a back-up steering system of a vehicle.

6. The hydraulic system of claim 4, further including:
a sensor configured to communicate a signal indicative of a parameter of a steering system; and
the controller being configured to selectively control two of the plurality of valves to selectively increase the amount of resistive torque applied to the associated traction devices as a function of the steering command when the signal is below a predetermined value.

7. The hydraulic system of claim 6, wherein the steering system is a primary steering system of a vehicle and the predetermined value is indicative of a threshold value below which the primary steering system malfunctions.

8. The hydraulic system of claim 1, wherein:
the hydraulic system is configured as at least a portion of a braking system of a vehicle; and
the controller is further configured to selectively increase the resistive torque on at least one of the plurality of traction devices when a second system, configured to control an orientation of at least one of the plurality of traction devices, is determined to be malfunctioning.

9. The hydraulic system of claim 8, wherein the controller determines that the second system is malfunctioning as a function of a received signal indicative of a pressure of pressurized fluid within the second system.

10. A method of operating a hydraulic system comprising:
pressurizing a fluid;
directing pressurized fluid to a plurality of valves, each one of the plurality of valves operatively associated with one of a plurality of actuators;
selectively directing pressurized fluid through each of the plurality of valves toward the plurality of actuators as a function of a first signal; and
selectively directing pressurized fluid through a subgroup of the plurality of valves as a function of a second signal.

11. The method of claim 10, wherein the first signal is indicative of an operator input to reduce the speed of movement of a vehicle and the second signal is indicative of an operator input to change the direction of movement of the vehicle.

12. The method of claim 10, further including controlling an amount of flow area of each of the plurality of valves to selectively direct pressurized fluid therethrough.

13. The method of claim 12, further including controlling the amount of flow area of each of the plurality of valves to a first position to allow a flow of fluid toward the plurality of actuators as a function of the first signal and selectively increasing the flow area of the subgroup of the plurality of valves as a function of the second signal.

14. The method of claim 12, further including controlling the amount of flow area of each of the plurality of valves to a first position to substantially block a flow of fluid toward the plurality of actuators as a function of the first signal and selectively controlling the amount of flow area of the subgroup of the plurality of valves to a second position to allow a flow of fluid toward a subgroup of the plurality of actuators in response to the second signal.

15. A vehicle comprising:
a frame;
a plurality of traction devices operatively connected to the frame;
a first system configured to affect a desired direction of movement of the vehicle relative to a surface as a function of a first operator input; and
a second system configured to:
selectively affect a desired speed of movement of the vehicle relative to the surface as a function of a second operator input, and
automatically affect the desired direction of movement of the vehicle relative to the surface when the first system is determined to be incapable of affecting the desired direction of movement.

16. The vehicle of claim 15, wherein the second system is a hydraulic system including:
a source of pressurized fluid;
a low pressure source of fluid;
a plurality of fluid actuators operatively connected to the plurality of traction devices; and
a plurality of valves configured to selectively direct pressurized fluid from the source to the plurality of fluid actuators.

17. The vehicle of claim 15, wherein the first system is determined to be incapable of affecting the desired direction of movement by:
sensing at least one operating parameter of the first system;
comparing the at least one sensed operating parameter to a predetermined value; and
determining that the first system is incapable of affecting the desired direction of movement if the at least one sensed operating parameter is less than the predetermined value.

18. The vehicle of claim 15, wherein:
the first system is configured to achieve a plurality of turning radii of the vehicle from a minimum turning radius to a maximum turning radius; and
the desired direction of movement is a turning radius smaller than the minimum turning radius.

19. The vehicle of claim 15, wherein the first system is a primary steering system and the second system is a combined braking and secondary steering system, the second system configured to affect the desired direction of movement of the vehicle as a function of the first operator input when the first system is malfunctioning.

20. The vehicle of claim 15, wherein selectively affecting the desired speed of movement of the vehicle selectively reduces the speed of movement of the vehicle.

21. The vehicle of claim 15, wherein the second system is further configured to affect the desired speed of movement of the vehicle before to automatically affecting the desired direction of movement of the vehicle.
